(19) United States
(12) Patent Application Publication
(10) Pub. No.: US 2008/0113757 A1
(43) Pub. Date: May 15, 2008

(54) Gaming Machine and Gaming Method Thereof

(75) Inventor: Hiro SAKUMA, Tokyo (JP)

Correspondence Address: BANNER & WITCOFF, LTD., 1100 13th STREET, N.W., SUITE 1200, WASHINGTON, DC, 20005-4051, US

(73) Assignee: ARUZE CORP., Tokyo (JP)

(21) Appl. No.: 11/939,833

(22) Filed: Nov. 14, 2007

(30) Foreign Application Priority Data
Nov. 14, 2006 (JP) 2006-307353

(51) Int. Cl. A63F 13/00

(52) U.S. Cl. 463/20

(57) ABSTRACT

A gaming environment, in which in a unit game after bet number is set, under a condition that a symbol combination constructed from the symbols rearranged displayed on the pay line is a winning combination, privileges such as payout may be provided to a player is described. Especially a gaming environment, in which when the unit game is in an available period, the payout amount provided to the player is increased. The increasing of the payout amount is obtained by multiplying a number which is corresponding to the number of the remained unit game in an available period. And the number used in the multiplication and the increased payout amount may be displayed on the display portion, is described.

### CROSS-REFERENCE TO RELATED APPLICATIONS

This application is based upon and claims a priority from the prior Japanese Patent Application No. 2006-307353 filed on Nov. 14, 2006, the entire contents of which are incorporated herein by reference.

### BACKGROUND

1. Field

The present invention relates to a gaming machine and a gaming method in which a bet number is set for each unit game.

2. Description of Related Art

In a conventional slot machine, a pay line or pay lines is/are activated when a bet number is set for a unit game by a player. And when a symbol combination constructed from symbols of reels, which are controlled to rotate, is stopped along the pay line and such symbol combination becomes a winning symbol combination, a player can get an award according to which a payout is provided.

Here, as a setting manner to set the bet number, there exist various manners such as a manner capable of setting and changing the bet number every pay line or a manner to activate all pay lines by one bet. And it is known a gaming machine in which a number of pay lines is changed corresponding to the bet number.

Here, concerning the bet number which becomes an important game element similar to the pay line, in a case that a new concept is added to a content about the bet number, influence given to feeling of the player becomes large, therefore there is a possibility that an entertaining characteristic is newly produced.

### SUMMARY

In view of the foregoing, one or more aspects of the present invention relate to a gaming machine, a gaming method thereof, a game system, a computer readable medium having computer-executable instructions or the like. According to the subject matter of the present invention, it can be provided a gaming machine and a gaming method thereof, in which a new entertaining characteristic is realized by adding a new manner for betting a bet number.

One or more of the above aspects of the invention is more fully described in the following detailed description when read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrating embodiments of the invention and, together with the description, serve to explain the objects, advantages and principles of the invention.

FIG. 1 is an explanatory view showing a characteristic of a slot machine according to the embodiment.

FIG. 2 is a perspective view of the slot machine according to the embodiment.

FIG. 3 is a schematic view schematically showing symbol rows displayed on reel strips of video reels utilized in the slot machine according to the embodiment.

FIG. 4 is a block diagram schematically showing a control system of the slot machine according to the embodiment.

FIG. 5 is a first payout table showing winning combinations and payouts corresponding to the winning combinations, the first payout table being utilized in a base game conducted by using the video reels.

FIG. 6 is a second payout table showing multiples for the payouts during an available period, the second payout table being utilized in the base game conducted by using the video reels.

FIG. 7 is an explanatory view showing content displayed on a lower image display panel of the slot machine according to the embodiment.

FIG. 8 is an explanatory view showing the content displayed on a lower image display panel of the slot machine according to the embodiment.

FIG. 9 is an explanatory view showing the content displayed on a lower image display panel of the slot machine according to the embodiment.

FIG. 10 is an explanatory view showing the content displayed on a lower image display panel of the slot machine according to the embodiment.

FIG. 11 is a flowchart of a main control program executed in the slot machine according to the embodiment.

FIG. 12 is a flowchart of a main game process program executed in the slot machine according to the embodiment.

FIG. 13 is a flowchart of a preliminary setting process program executed in the slot machine according to the embodiment.

FIG. 14 is a flowchart of a symbol display process program executed in the slot machine according to the embodiment.

### DETAILED DESCRIPTION

The various aspects summarized precedingly may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A gaming machine according to one or more aspects of the invention is described in detail with reference to the drawings based on an embodiment embodying one or more aspects of the invention as a slot machine, a server, a game system. However, it is appreciated that one or more aspects of the present invention may be embodied in distributable (via CD and the like) or downloadable software games, console games, and the like. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application or the like that runs in a processor or processors. Further, the terms “CPU” and “processor” are inclusive by nature, including at least one of hardware, software, or firmware. These terms may include a side of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

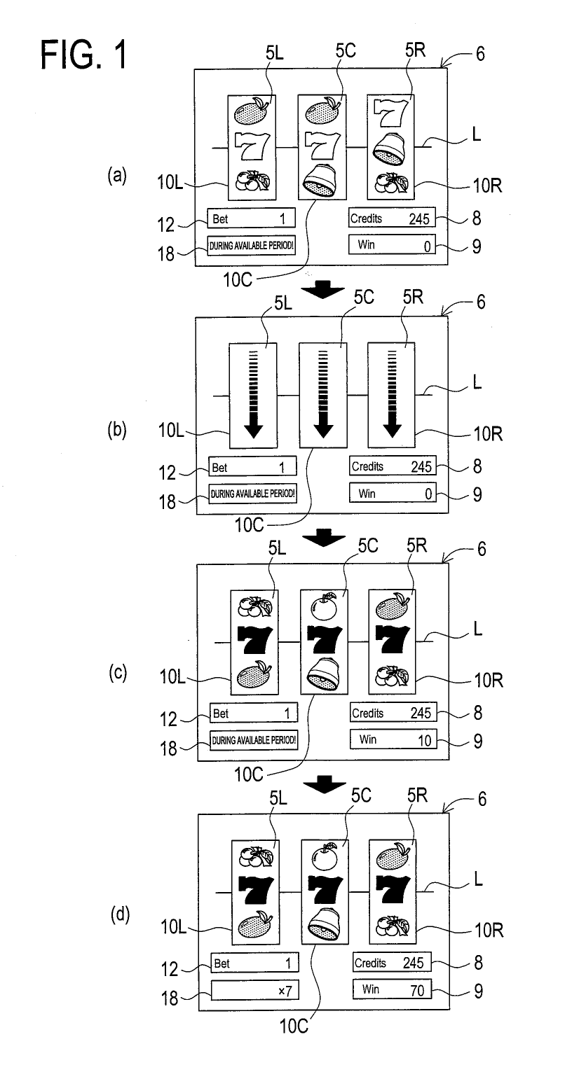

FIG. 1 is an explanatory view showing a characteristic of a slot machine according to the embodiment. When a lower image display panel 6 shown in FIG. 1 is specified, it is described by a number of stage counted from an upper stage.

In the slot machine according to the embodiment, on the lower image display panel 6 which is a video display, when a base game is executed as shown in FIG. 1(a), three visible display windows 10L, 10C and 10R are displayed. Through each of the display windows 10L, 10C and 10R, three symbols displayed on each of reel strips of video reels 5L, 5C, and 5R are respectively arranged and displayed. On the lower image display panel 6, one pay line L, which crosses the three display windows 10L, 10C, 10R horizontally, is formed. The pay line L is used to define a symbol combination. And a credit number display portion 8, a payout amount display portion 9, and a bet number display portion 12 are arranged on the lower image display panel 6. Here, various winning symbol combinations are predetermined based on kinds of the symbol combinations.

Also, during an available period, an available period display portion 18 is arranged on the lower image display panel 6, and a message of “DURING AVAILABLE PERIOD” is displayed within the available period display portion 18.

Here, the available period in the embodiment is constructed from a period during which unit games are continuously conducted ten times. However, the unit game which becomes a start point of the available period (abbreviated as “starting game” hereinafter), is set by the player just before such unit game is started. In the embodiment, the setting of the starting game by a player can be done only in a case that an insurance, based on which a predetermined payout amount (for example, 100 credits) is paid to the player corresponding to that the unit game is repeated in a predetermined number of times (for example, 100 times), is betted by the player.

In each unit game, the video reels 5L, 5C and 5R spin on the lower image display panel 6 as shown in FIG. 1(b) and stop on the lower image display panel 6 as shown in FIG. 1(c). Thereby, three symbols are rearranged and displayed in each of the display windows 10L, 10C and 10R respectively. At that time, when the symbol combination constructed from three symbols which are rearranged and stopped on the pay line L becomes any one of the winning symbol combinations, the payout amount corresponding to such winning symbol combination is paid out to the player.

Here, such payout amount is displayed in the payout number display portion 9.

Furthermore, when the unit game is conducted during the available period, the payout amount provided to the player is increased as shown on the lower image display panel 6 in FIG. 1(d). Here, increase of the payout amount is made by multiplying a predetermined number which is predetermined corresponding to a remaining number of times of the unit games included in the available period. The number used for the multiplication is displayed in the available period display portion 18. Here, on the lower image display panel 6 shown in FIG. 1(d), “×7” is displayed in the available period display portion 18, therefore the payout amount displayed in the payout amount display portion 9 in FIG. 1(d) becomes seven times in comparison with that shown in the payout amount display portion 9 in FIG. 1(c).

Hereinafter, the embodiment embodying the present invention is described in detail with reference to the drawings.

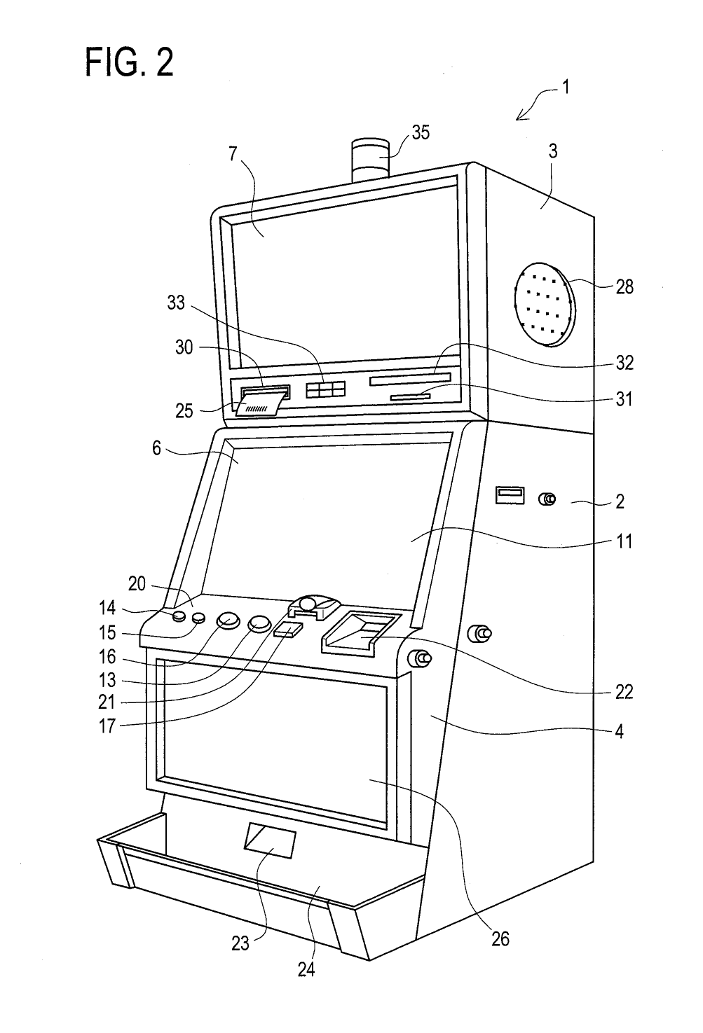

At first, an outline construction of the slot machine 1 of the embodiment may be described with reference to FIG. 2. FIG. 2 is a perspective view showing the slot machine of the embodiment.

The slot machine 1 includes a cabinet 2, a top box 3, and a main door 4. The top box 3 is arranged on the cabinet 2 (for instance, arranged on the upper side). The main door 4 is arranged in front of the cabinet 2.

In front of the top box 3, an upper image display panel 7 is arranged.

Here, the upper image display panel 7 is constructed from a well-known transparent liquid crystal panel. Generally, on the upper image display panel 7, game information of the slot machine 1 such as demonstration images, game rules and payout tables may be displayed.

The lower image display panel 6 is arranged on the upper front side of the main door 4, as a video display. The lower image display panel 6 may be constructed, for instance, from well-known transparent liquid crystal panel. Here, the lower image display 6 may be CRT, liquid crystal display, plasma display, LED display, OLED display, and other known display technologies.

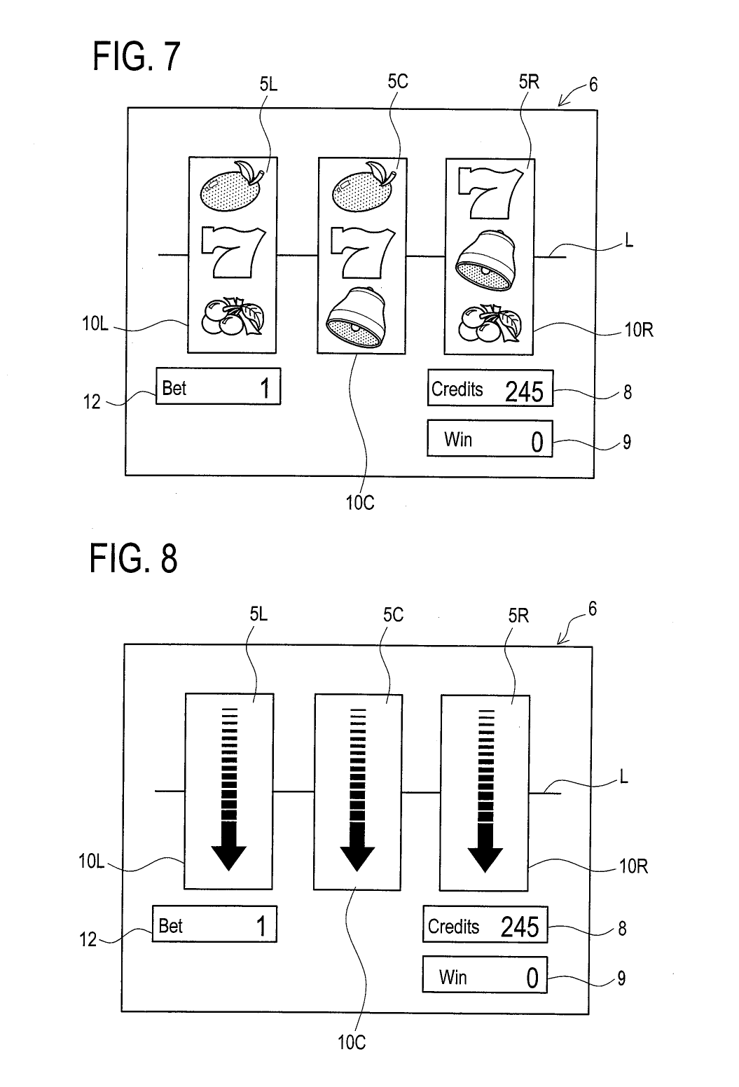

Here, game images regarding to a base game executed in the slot machine 1 displayed on the lower image display panel 6 will be described. FIG. 7 to FIG. 10 are explanatory views showing the content displayed on the lower image display panel 6. On the lower image display panel 6, the symbols of reel strips displayed on each reel 5L, 5C, 5R are made visible through display windows 10L, 10C and 10R during the base game, as shown in FIGS. 7 and 8. FIG. 7 is an explanatory view showing the display state of the symbols displayed on the reel strips of the video reels 5L, 5C and 5R, the symbols being displayed after arranged or rearranged in the display windows 10L, 10C and 10R of the lower image display panel 6. FIG. 8 is an explanatory view showing the rotating state of the symbols displayed on the reel strips of the video reels 5L, 5C and 5R.

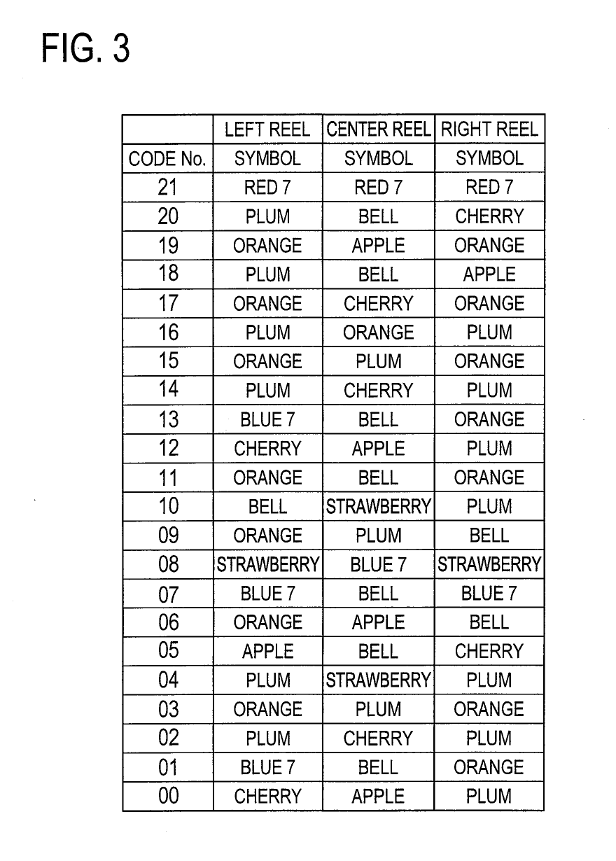

Here, on each reel strip of three reels 5L, 5C and 5R, a symbol row (see FIG. 3) constructed from twenty-two symbols is described.

A touch panel 11 (see FIG. 2) is arranged in front of the lower image display panel 6, and the player may input various instructions by operating the touch panel 11 (see FIG. 2).

Further, the credit count display portion 8, the payout amount display portion 9 and the bet number display portion 12 are arranged on the lower image display panel 6. In the credit number display portion 8, the credit number currently owned by the player may be displayed. In the payout amount display portion 9, there are displayed as the payout number the payout amount given to the player when the symbol combination rearranged and displayed on the pay line L is a predetermined winning symbol combination and the payout amount obtained in a bonus game. In the bet number display portion 12, a bet number betted in each base game at present by the player may be displayed.

That is to say, on the lower image display panel 6, three visible display windows 10L, 10C and 10R are formed. And three symbols displayed on each of the reel strips of the reels 5L, 5C and 5R are respectively arranged and displayed through each of the display windows 10L, 10C and 10R.

On the lower image display panel 6, as shown in FIG. 7 and FIG. 8, a pay line L which horizontally crosses the three display windows 10L, 10C, 10R is formed. The pay line L is used to define the combination of the three symbols.

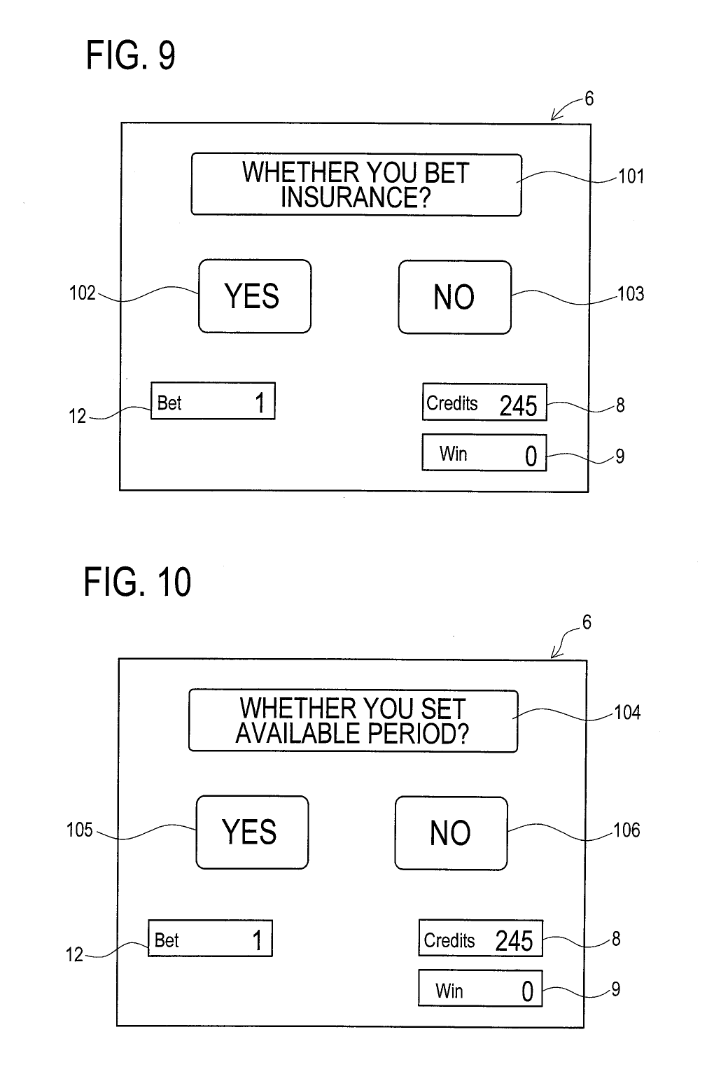

When the insurance is not bet, a first setting screen shown in FIG. 9 is displayed on the lower image display panel 6 right before the unit game in the base game is started. Here, on the first setting screen displayed on the lower image display panel 6, there are formed a display frame 101 in which a massage “whether you bet insurance?” is displayed, a “YES” button 102 and a “NO” button 103.

And when the “YES” button 102 is pressed by the player through the touch panel 11 (see FIG. 2), the insurance is betted from the unit game conducted thereafter. On the other hand, when the “NO” button 103 is pressed by the player through the touch panel 11 (see FIG. 2), the status without betting the insurance is retained thereafter.

When it is not during the above available period, a second setting screen shown in FIG. 10 is displayed on the lower image display panel 6 right before the unit game of the base game is started. Here, on the second setting screen displayed on the lower image display panel 6, there are formed a display frame 104 in which a message “whether you set available period?” is displayed, a “YES” button 105 and a “NO” button 106.

And when the “YES” button 105 is pressed by the player through the touch panel 11 (see FIG. 2), the available period is set to each unit game thereafter. On the other hand, when the “NO” button 106 is pressed by the player through the touch panel 11 (see FIG. 2), the status without setting the available period is retained thereafter.

Here, in the bonus game, a predetermined bonus screen in which the display windows 10L, 10C, 10R (including each of the video reels 5L, 5C, 5R), the play line L, the bet number display portion 12 and the available period display portion 18 are erased, is displayed concurrently with the credit number display portion 8 and the payout amount display portion 9.

Returning to FIG. 2, at the lower side of the lower image display panel 6, there are arranged a control panel 20 on which a plurality of buttons to input instructions instructing game progress are arranged, a coin insertion slot 21 for inserting coins as the game media into the cabinet 2 and a bill verifier 22.

On the control panel 20, a spin button 13, a change button 14, a cashout button 15, a 1-bet button 16 and a max-bet button 17 are arranged. The spin button 13 may be used when the instruction for the spinning start of the video reels 5L, 5C and 5R is input. The change button 14 is used when the player requires the exchange to a shopkeeper of the game arcade. The cashout button 15 is a button to input the instruction for payment of the coins (for example, one credit is equal to one coin) corresponding to the credit number from a coin payout opening 23 to a coin tray 24 or the instruction for payment coins by using a ticket with a bar code 25 (mentioned later). Bar codes may be printed on the ticket 25. The ticket 25 may be called GAMING VOUCHER.

The 1-bet button 16 is used when it is input the instruction for betting one credit from all credits owned by the player. The max-bet button 17 is used when it is input the instruction for betting the maximum bet number bettable in one game (in the embodiment, three credits) from the credits owned by the player.

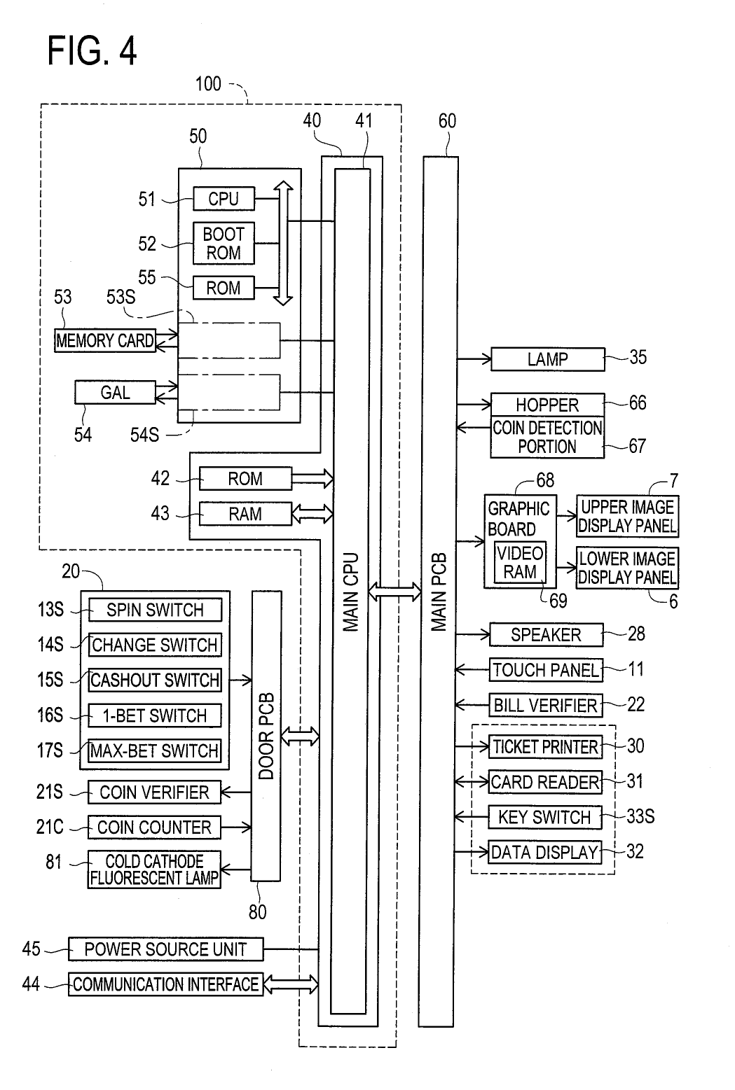

A coin verifier 21S and a coin counter 21C (see FIG. 4) are arranged inside of the coin slot 21. The coin verifier 21S verifies whether coins inserted from the coin insertion slot 21 are true or false, and coins except for true coins may be discharged through the coin payout opening 23. The coin counter 21C (see FIG. 4) detects qualified coins and counts the number of the coins.

The bill verifier 22 verifies the bill and receives qualified bill into the cabinet 2. The bill which is received into cabinet 2 is converted to the coin number, and the credit number corresponding to the converted coin number may be added to the credit number owned by the player. The bill verifier 22 is constructed so as to read a ticket 25 (which may be described later). At the lower front position, that is, under the control panel 20, a belly glass panel 26 on which characters of the slot machine 1 are described is arranged.

In the slot machine 1 of the embodiment, the gaming medium may be coin, bill, or electronic value (credit). Here, the gaming medium may be others as well (including but not limited to medal, token, electronic money, or ticket).

A ticket printer 30, a card reader 31, a data display 32, and a keypad 33 are arranged at the lower position of the upper image display panel 7.

The ticket printer 30 prints and outputs the ticket 25 with the bar code in which the data (such as credit number, time data, or ID number of the gaming machine) is coded. A player may use the ticket 25 with the bar code at other gaming machines by reading the ticket through the gaming machine. Also the ticket 25 may be used to go through some procedures in the predetermined place of the game arcade by the player.

The card reader 31 reads data from a smart card and writes data into the smart card. The smart card is owned by a player, and the gaming record of the player is stored in the smart card.

The data display 32 is formed from a luminescent display and the data (which is read by the card reader 31 or input by the player via the keypad 33) may be displayed on the data display 32. The keypad 33 may be used when the player input data or the instruction relating to the print of the ticket. A lamp 35 is arranged at the top box 3 (for example, arranged on top). The lamp 35 may be turned on with a predetermined pattern when the player wants call a shopkeeper of the game arcade, or at the time error occurs in the slot machine 1.

And the numeral 28 indicates a speaker.

Next, with reference to FIG. 3, it will be explained the symbols, which are described on each reel strip adhered to each outer surface of the reels 5L, 5C, 5R and rearranged and displayed through the display windows 10L, 10C, 10R of the lower image display panel 6 during the game after being scrolled. FIG. 3 is a view schematically showing the symbols displayed on the each of the reels 5L, 5C and 5R.

On the reel strips of the left video reel 5L, the center video reel 5C and the right video reel 5R, twenty-two symbols are displayed respectively. Each symbol row is formed by combining “RED 7”, “Blue 7”, “BELL”, “CHERRY”, “STRAWBERRY”, “PLUM”, “APPLE”, “ORANGE”. As shown in FIG. 3, on each reel strip of the reel 5L, 5C, 5R, predetermined kinds of symbols are arranged with a predetermined sequence.

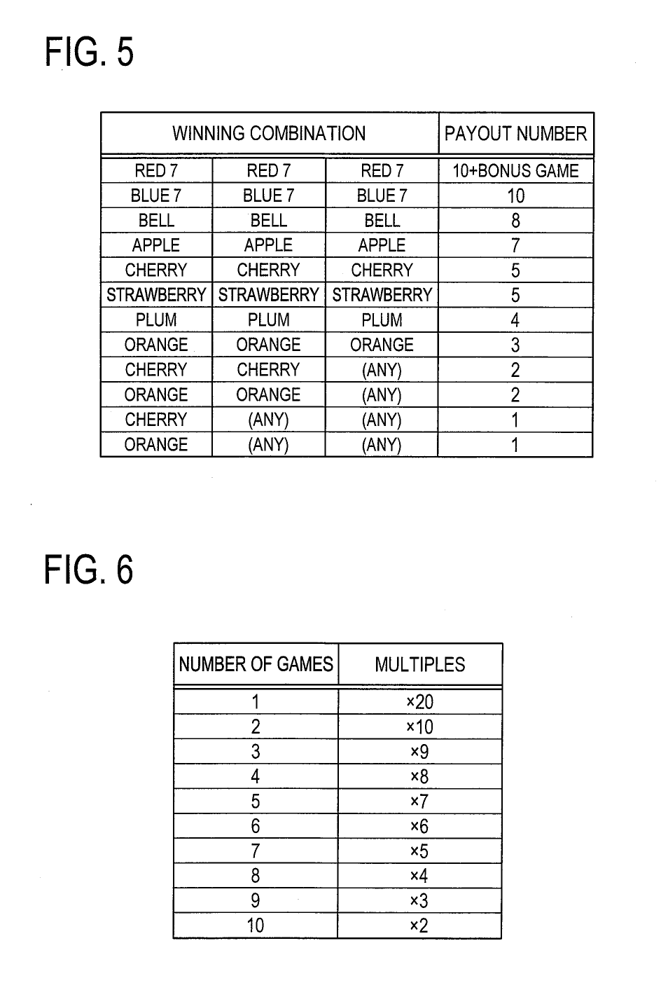

When three symbols of the “BLUE 7”, “BELL”, “CHERRY”, “STRAWBERRY”, “PLUM”, “APPLE” and “ORANGE”, are rearranged and displayed on the pay line L of the lower image display panel 6, a predetermined payout amount may be provided to the player (see FIG. 5). When one or two symbols of the “CHERRY” and “ORANGE”, are rearranged and displayed on the pay line L, a predetermined payout amount may be provided based on the number thereof (see FIG. 5).

When three symbols of the “RED 7” are rearranged and displayed on the pay line L of the lower image display panel 6, a bonus game may be executed in addition to a predetermined payout amount. Here, the game executed in the slot machine 1 according to the embodiment, is constructed from two game modes of the base game and the bonus game. In the base game, a slot game is executed, wherein each of specific symbol combinations is rearranged and displayed on the pay line L, through the reel 5L, 5C and 5R on the lower image display panel 6. Regarding to the bonus game, it may be described later.

In the bonus game, three treasure boxes which are the selection items may be displayed on the lower image display panel 6. And the game is conducted by providing the payout amount corresponding to the selected three treasure boxes to the player. And the detail regarding to the bonus game will be omitted here.

A part of the symbol rows displayed on each reel strip of the video reels 5L, 5C and 5R shown in FIG. 3, is displayed in the display windows 10L, 10C and 10R. Thereby, in each of the display windows, three symbols are arranged. Thus, nine symbols are totally rearranged and displayed in the display windows 10L, 10C and 10R.

When the bet number is determined based on the operation of the 1-bet button 16 or max-bet button 17, and then the spin button 13 is input, the reels 5L, 5C and 5R may start to spin. Accordingly, the symbol rows displayed on the reels 5L, 5C and 5R, are scrolled from top to bottom in the display windows 10L, 10C and 10R, and then displayed (see FIG. 8).

After a predetermined time, the reels 5L, 5C and 5R may end spinning. Three symbols are shown in each of the display windows. Accordingly, nine symbols are totally rearranged and displayed in the display windows 10L, 10C and 10R (see FIG. 7). Here, winning combinations of the symbols are set beforehand according to symbol combinations (see FIG. 5). If the symbols, which are rearranged and displayed on the pay line L, form a winning combination, the payout amount corresponding to the winning combination displayed on the pay line L may be provided to the player.

A control system of the slot machine 1 according to the embodiment may be described with reference to FIG. 4. FIG. 4 is a block diagram schematically showing the control system of the slot machine 1 according to the embodiment.

The control system of the slot machine 1 may be constructed from a mother board 40 and a gaming board 50 as shown in FIG. 4. The gaming board 50 may be constructed from a CPU 51, a ROM 55, a boot ROM 52, a card slot 53S, and an IC socket 54S. The CPU 51, the ROM 55, the boot ROM 52 are interconnected via internal bus. The card slot 53S is adapted to receive the memory card 53. The IC socket 54S is adapted to receive a GAL (Generic Array Logic) 54.

The memory card 53 may be constructed from non-volatile memory. A game program and a game system program (hereinafter, “the game program and the like”) are stored therein. The game program stored in the memory card 53 may include a lottery program.

The lottery program is used to determine the symbols (code numbers corresponding to the symbols) of each of the reels 5L, 5C and 5R, rearranged and displayed on the pay line L. Symbol tables of the base game and the bonus game are included in the lottery program. In the lottery program, it is included symbol weighing data corresponding to each of plural kinds of payout rates (for example, 80%, 84%, 88%). The symbol weighing data are the data indicating correlation between the code Nos. (see FIG. 3) of each symbol and one or plural random numbers belonging to a predetermined range (0˜255), every each of three reels 5L, 5C and 5R. In other words, each of the code No. of one symbol is associated with one or more random numbers. The random number is extracted by the lottery program, and the symbol corresponding to the random number is rearranged and displayed on the lower image display panel 6.

The payout rates are determined based on the payout rate setting data output from the GAL 54. And the lottery is executed based on the symbol weighing data corresponding to the payout rate.

The card slot 53S is constructed so that the memory card 53 is detachable, and is connected to the mother board 40 via IDE bus. The kind and the contents of the game executed in the slot machine 1 may be changed by rewriting the game program and the like stored in the memory card 53. Also, the kinds and the contents of the games executed in the slot machine 1 may be changed by exchanging the memory card 53 in which another game program or the like is stored.

The game program may include the program related to the gaming session, the image data and sound data output during the game. Also the image data showing the symbols displayed on each of the three reels 5L, 5C and 5R, the image data of the game rules or the payout table, and the image data for demonstration are included in the game program.

The GAL 54 may be one of the PLD, which may contains a fixed OR array. The GAL 54 includes plural input ports and output ports. If predetermined data is input to the input port (s), the data corresponding thereto may be output to the output port (s). The output data from the output port is the payout rate setting data.

The IC socket 54S is constructed so that the GAL 54 is detachable, and is connected to the mother board 40 via PCI bus. The payout rate setting data may be changed by rewriting the GAL 54 or by exchanging the GAL 54 itself.

The CPU 51, the ROM 55, and the ROM 52 are connected to the mother board 40 via the PCI bus. The CPU 51, the ROM 55, and the boot ROM 52 are interconnected via internal bus. The PCI bus transmits the signal between the mother board 40 and the gaming board 50. The mother board 40 supplies the electric power to the gaming board 50 by the PCI bus. The country ID and the verification program are stored in the ROM 55. The preliminary verification program and the boot code may be stored in the boot ROM 52. The CPU 51 may boot the preliminary verification program with the use of the boot code.

The verification program is used to verify the game program and the like. The verification program is executed to check whether or not falsification of data has been done in the game program and the like. The game program and the like may be the object of the verification process. A preliminary verification program may be used to verify the verification program. The preliminary verification program is written along the procedure for the check of falsification of the verification program. The verification program may be the object of the preliminary verification process.

The mother board 40 may be described. The mother board 40 may be constructed from general mother board (printed circuit board which mounts basic components of a personal computer), and may include a main CPU 41, a ROM 42 and a RAM 43.

The ROM 42 may be constructed from a memory device such as the flash memory (for example). The perpetual data may be stored in the ROM 42. The perpetual data includes the BIOS program, the lottery table in the base game and in the bonus game, the first payout table (see FIG. 5) and the second payout table (see FIG. 6) The BIOS program may be executed by the main CPU 41. When the BIOS is executed by the main CPU 41, the initial process for predetermined peripheral devices, and the read process for the game program and the like stored in the memory card 53 may be started via the gaming board 50.

The data and the program, which are used when the main CPU 41 runs, are stored in the RAM 43. The verification program which may be read via the gaming board 50, various programs such as the game program and the like, the credits number owned by the player may be stored in the RAM 43. Also in the RAM 43, the memory area regarding to the after-mentioned variable N or M is secured.

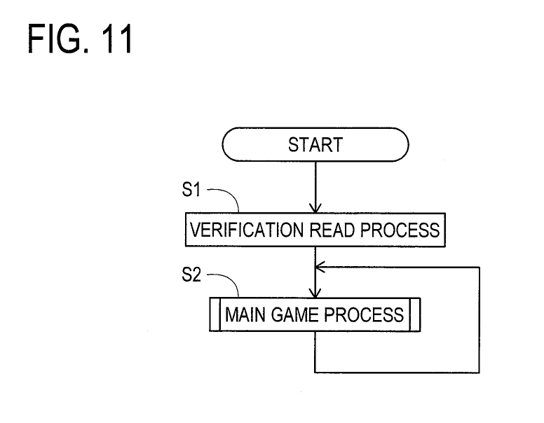

A communication interface 44 is connected to the mother board 40. The communication interface 44 may be a communication device communicating with the server located in the game arcade via a communication line or other communication pathway. In the slot machine 1, bet information in the main game process (which may be described later, see S2 of FIG. 11) and/or the lottery result of a base game lottery process may be communicated with the server via the communication interface 44.

A main PCB (Printed Circuit Board) 60 and a door PCB 80 (which may be described later) are connected to the mother board 40 respectively via USB (for example). When the power source unit 45 supplies the electric power to the mother board 40, the main CPU 41 on the mother board 40 may be booted up. The CPU 51 may be booted up by supplying the electric power to the gaming board 50.

A game controller 100 is constructed from the mother board 40 and the gaming board 50.

To the main PCB 60 and the door PCB 80, devices generating the input signals to the game controller 100 and devices controlled by the control signals from the game controller 100, are connected. The game controller 100 executes the game program and the like stored in the RAM 43 based on the input signal which is input thereto. The CPU 41 stores the calculation result in the RAM 43 and controls some devices by executing predetermined calculation process.

The lamp 35, a hopper 66, a coin detection portion 67, a graphic board 68, the speaker 28, a touch panel 11, the bill verifier 22, the ticket printer 30, the card reader 31, a key switch 33S, and a data display 32 may be connected directly or indirectly to the main PCB 60.

The touch panel 11 may be arranged in front of the lower image display panel 6. The touch panel 11 may specify the coordinate information of the portion touched by the player. And based on the specified coordinate information, the touch panel 11 may realize where the player touches, and the direction of the movement corresponding to the portion touched by the player.

The hopper 66 is arranged inside of the cabinet 2. The hopper 66 pays out a payout with coins through the coin payout opening 23 to the coin tray 24 based on the control signal from the game controller 100. The coin detection portion 67 is arranged inside of the coin payout opening 23. When the coin detection portion 67 detects that predetermined coins are paid through the coin payout opening 23, the coin detection portion 67 may output the signal to the game controller 100.

The graphic board 68 controls the image display on the upper image display panel 7 and the lower image display panel 6 based on the control signal from the game controller 100. The player's credit number, stored in the RAM 43, may be displayed on the credit number display portion 8. The credit amount corresponding to the payout may be displayed on the payout amount display portion 9. On the bet number display portion 12, a bet number betted by the player may be displayed. And the display control is also executed by the graphic board 68. The display control includes the control regarding to the available period display portion 18, and the display control regarding to the stage screen of each stage in the bonus game.

The graphic board 68 may include a VDP (Video Display Processor) and a video RAM 69. The VDP is used to generate image data based on the control signals from the game controller 100. The image data generated by the VDP are temporarily stored in the video RAM 69. The image data to generate the image data by the VDP may be included in the game program.

Also, the display control is executed by the graphic board 68, based on the control signals from the game controller 100, so that the reels 5L, 5C and 5R are variably rotated and stopped on the lower image display panel 6 (see FIG. 1, FIG. 7 and FIG. 8).

The bill verifier 22 verifies the bill or the ticket 25 with bar code. The bill verifier 22 receives the qualified bill or the ticket 25 with bar code into the cabinet 2. When qualified bill is inserted, the bill verifier 22 may output signals to the game controller 100 based on the value thereof. When qualified ticket 25 is inserted, the bill verifier 22 may output signals to the game controller 100 based on the bar code indicating the number of coins printed thereon.

The ticket printer 30 prints the ticket with the bar code, in which the data such as credit number stored in the RAM 43 are coded, based on the control signal from the game controller 100. The ticket printer 30 outputs the printed ticket as the ticket 25 with bar code.

The card reader 31 reads data from the smart card, and transmits data to the game controller 100, based on the control signals from the game controller 100. A key switch 33S is arranged on the keypad 33. When the keypad 33 is operated by the player, the predetermined input signal may be output to the game controller 100. On the data display 32, the data read by the card reader 31 or the data input by the player via the keypad 33, may be displayed based on the control signal from the game controller 100.

The control panel 20, the coin verifier 21S, the coin counter 21C, and a cold cathode fluorescent lamp 81 are directly or indirectly connected to the door PCB 80. A spin switch 13S, a change switch 14S, a cash-out switch 15S, a 1-bet switch 16S, and a max-bet switch 17S are arranged on the control panel 20. The spin switch 13S is associated with the spin button 13. The change switch 14S is associated with the change button 14. The cash-out switch 15S is associated with the cash-out button 15. The 1-bet switch 16S is associated with the 1-bet button 16. The max-bet switch 17S is associated with the max-bet button 17. Each of the switches may output the input signal to the game controller 100 when the button corresponding thereof is operated by the player.

The coin counter 21C is arranged inside of the coin insertion slot 21. The coin counter 21C verifies the coin inserted from the coin insertion slot 21 by the player. Any fake coin may be discharged through the coin payout opening 23. When a qualified coin is detected, the coin counter 21C may output the signal to the game controller 100.

The coin verifier 21S is controlled based on the control signal from the game controller 100. The coin verifier 21S sorts the qualified coins into a cash box (not shown) or the hopper 66. The cash box is arranged inside of the slot machine 1. The cold cathode fluorescent lamp 81 may be arranged on the back side of the lower image display panel 6 and the upper image display panel 7. The cold cathode fluorescent lamp 81 functions as a back light and is turned on based on the control signal from the game controller 100.

The winning combination and payout thereof in the base game by using the video reels 5L, 5C and 5R in the slot machine 1 of the embodiment, may be described with reference to FIG. 5 and FIG. 6. FIG. 5 is the first payout table showing the winning combinations and the payouts corresponding to the winning combinations in the base game using the video reels 5L, 5C and 5R.

The payout amount shown in FIG. 5 indicates the case in which the bet number is “1”. When the bet number is “1”, the payout amount shown in FIG. 5 may be added to the credit number. When the bet number is more than “2”, the product obtained by multiplying the payout amount shown in FIG. 5 with the bet number, may be added to the credit number.

For example, when a bonus trigger is realized on the lower image display panel 6, three symbols of “RED 7” are rearranged and displayed on the pay line L, and a payout of 10 credits per bet may be provided to the player. Also, the bonus game is started.

When a winning combination of symbols “BLUE 7” is satisfied, on the lower image display panel 6, three “BLUE 7” symbols are rearranged and displayed on the pay line L, and a payout of ten credits per bet may be provided to the player.

When a winning combination of symbols “BELL” is satisfied, on the lower image display panel 6, three “BELL” symbols are rearranged and displayed on the pay line L, and a payout of ten credits per bet may be provided to the player.

Similar to the above, as shown in FIG. 5, the probability to realize the winning combination and the payout thereof are set every each winning combination. However, when it is rearranged and displayed on the lower image display panel 6 a symbol combination other than the winning combinations shown in FIG. 5, the game result becomes loss of game. In this case, no credit is paid out.

Regarding to the symbols of “ORANGE” or “CHERRY”, when one or two “ORANGE” or “CHERRY” symbols are rearranged and displayed on the pay line L, a payout of one credit or two credits per one bet may be provided to the player.

FIG. 6 is the second payout table showing the multiple of the payout amount during the available period, when the base game is executed by using the video reels 5L, 5C and 5R.

Here, each of the game numbers shown in FIG. 6 indicates the accumulated number of the unit game counted from the staring game. Therefore, during the available period, when the unit game in which the winning combination is satisfied, is the staring game of the available period, the multiple is “20”, and the payout amount provided to the player is twenty-times of the payout amount per winning combination. When the unit game in which the winning combination is satisfied, is the second game counted from the staring game, the multiple is “10”, and the payout amount provided to the player is ten-times of the payout amount per winning combination.

Similarly, when the unit game in which the winning combination is satisfied, is the third, forth, fifth, sixth, seventh, eighth, ninth and tenth game from the staring game, the multiple may be “9”, “8”, “7”, “6”, “5”, “4”, “3” and “2”. And the payout amount provided to the player is nine-times, eight-times, seven-times, six-times, five-times, four-times, three-times, two-times of the payout amount per winning combination respectively.

Next, a main control program, which is executed in the slot machine 1 according to the embodiment, will be described in detail with reference to the drawing. FIG. 11 is a flowchart of the main control program.

In the slot machine 1, the memory card 53 is connected to the card slot 53S of the gaming board 50, and the GAL 54 is connected to the IC socket 54S.

When the power switch of the power source unit 45 is ON, the game controller 100 is booted-up, and the verification read process (S1) is executed. In the verification read process, the mother board 40 and the gaming board 50 execute separate processes in parallel.

In the gaming board 50, the CPU 51 reads the preliminary verification program from the boot ROM 52, and verifies that the verification program is not falsified before the verification program is taken to the mother board 40.

In the mother board 40, the main CPU 41 executes BIOS stored in the ROM 42. BIOS may decompress the compressed data therein, and copy it to the RAM 43. When the BIOS stored in the RAM 43 is executed, the check and initialization of various peripheral devices may be executed.

The game controller 100 reads the verification program stored in the ROM 55, and verifies that game program and the like stored in the memory card 53 are not falsified. After the verification process is ended, the game controller 100 writes program to the RAM 43, and acquires payout rate setting data and country ID information.

After the process mentioned above is finished, the game controller 100 finishes the verification read process.

In S2, the game controller 100 reads the game program and the like which was verified in S1 from the RAM 43, and executes the main game process. The game in the slot machine 1 according to the embodiment is executed by executing the main game process. The main game process is executed repeatedly during the period when the electronic power source is supplied.

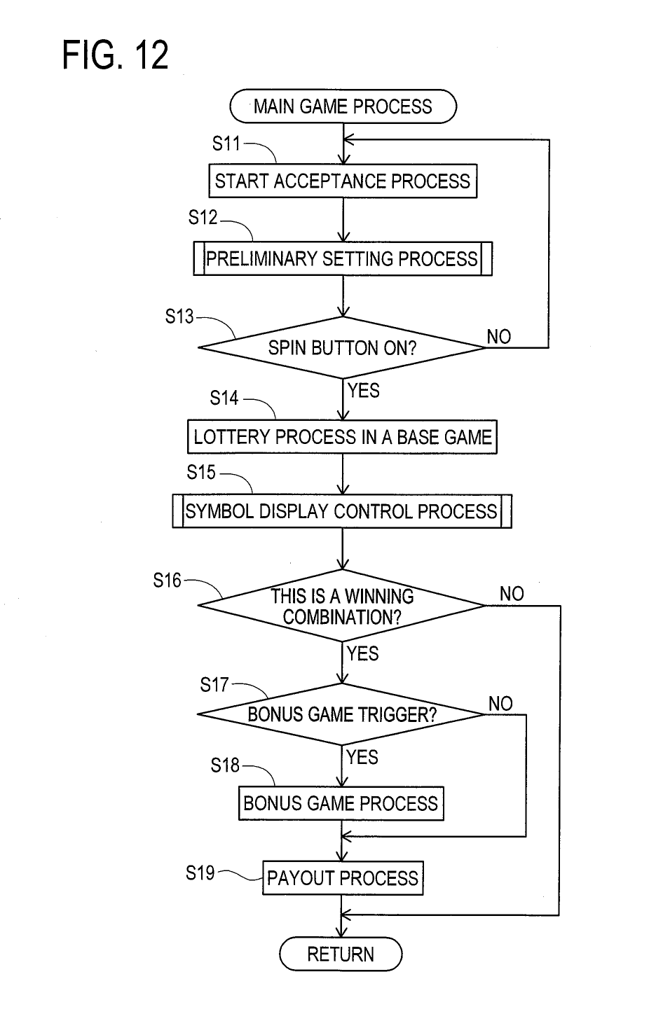

A sub-process of the main game process in S2 will be described with reference to FIG. 12. FIG. 12 is a flowchart of the main game process in the slot machine 1 according to the embodiment. Here, each of the programs shown in the flowcharts in FIG. 12 is stored in the ROM 42 and the RAM 43 included in the slot machine 1, and is executed by the game controller 100.

In S11 as shown in FIG. 12, the game controller 100 performs predetermined initial setting, and then, executes the start acceptance process such as the insertion of coins and the setting of the bet number. Here, in the start acceptance process, insertion of coins or the bet operation by using the 1-bet button 16 or max-bet button 17, is operated by the player.

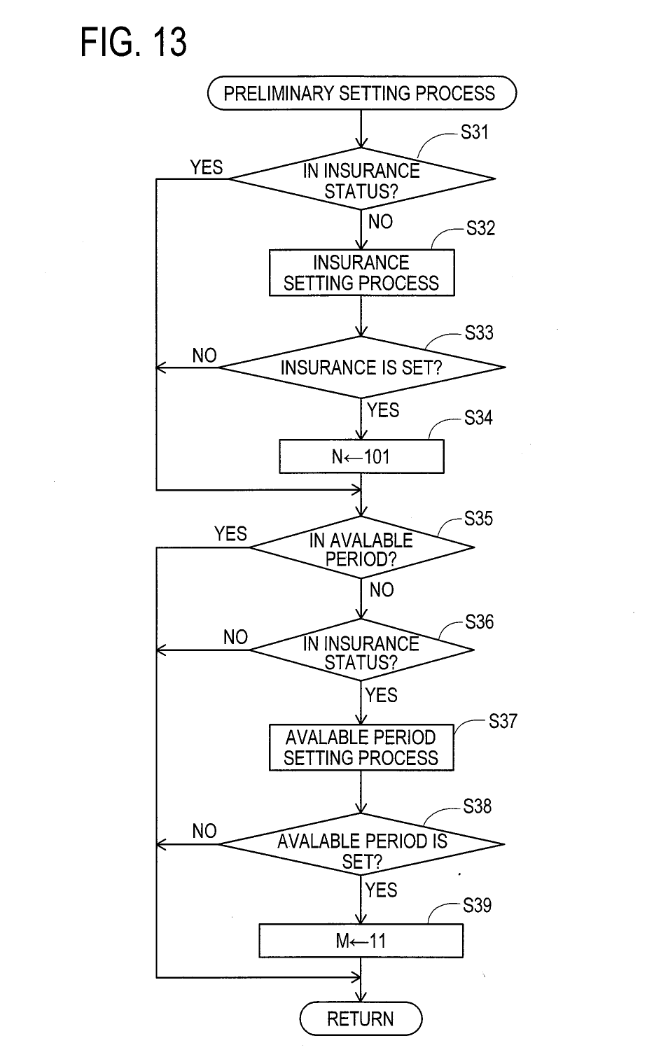

Next, in S12, a preliminary setting process is executed by the game controller 100. Here, the sub-process of preliminary setting process in S12 will be described with reference to FIG. 13. FIG. 13 is a flowchart of the preliminary setting process program in the slot machine 1 according to the embodiment. Each program shown in the flowchart of FIG. 13, may be stored in the ROM 42 or RAM 43 in the slot machine 1, and may be executed by the main CPU 41

First, in S31 as shown in FIG. 13, it is determined whether the game is in an insurance status by the game controller 100. An insurance status indicates the status in which an insurance is betted. Here, when the variable N is above “1”, then it is determined that the game is in an insurance status. When the variable N is under “1”, then it is determined that the game is not in an insurance status. When it is determined that the game is in an insurance status (S31: YES), procedure shifts to S35. When it is determined that the game is not in an insurance status (S31: NO), procedure proceeds to S32.

In S32, an insurance setting process is executed by the game controller 100. Concretely, the first setting screen shown in FIG. 9, is displayed on the lower image display panel 6 by the graphics board 68. Here, on the first setting screen displayed on the lower image display panel 6, a player may set an insurance by pressing the “YES” button 102. And a player may also not set an insurance by pressing the “NO” button 103.

And then in S33, it is determined whether an insurance is set by the game controller 100. Here, when the “YES” button 102 is pressed, it is determined that an insurance is set. And when the “NO” button 103 is pressed, it is determined that an insurance is not set. It is determined whether the “YES” button 102 or the “NO” button 103 is pressed based on the position information from the touch panel 11. When it is determined that an insurance is not set (S33: NO), procedure shifts to S35. When it is determined that an insurance is set (S33: YES), procedure proceeds to S34.

In S34, the variable N is substituted by “101” by the game controller 100. Here, the predetermined bet number is reduced from the credits owned by a player, and is stored in the RAM 43 as the betting information of the insurance.

In S35, it is determined whether the game is in an available period by the game controller 100. Here, when the variable M is bigger than “0”, it is determined that the game is in an insurance period. And when the variable M is under “0”, it is determined that the game is not in an insurance period. When it is determined that the game is in an available period (S35: YES), procedure returns to the main game process shown in FIG. 12. When it is determined that the game is not in an available period (S35: NO), procedure proceeds to S36.

In S36, it is determined whether the game is in an insurance status by the game controller 100. It is determined in a same way as in S31. When it is determined that the game is not in an insurance status (S36: NO), procedure returns to the main game process shown in FIG. 12. When it is determined that the game is in an insurance status (S36: YES), procedure proceeds to S37.

In S37, the available period setting process is executed by the game controller 100. Concretely, the second setting screen shown in FIG. 10 is displayed on the lower image display panel 6 by the graphics board 68. Here, on the second setting screen displayed on the lower image display panel 6, a player may set an available period by pressing the “YES” button 105. And a player may also not set an available period by pressing the “NO” button 106.

And then in S38, it is determined whether an available period is set by the game controller 100. Here, when the “YES” button 105 is pressed, it is determined that an available period is set. And when the “NO” button 106 is pressed, it is determined that an available period is not set. It is determined whether the “YES” button 105 or the “NO” button 106 is pressed based on the position information from the touch panel 11. When it is determined that an available period is not set (S38: NO), procedure returns to the main game process shown in FIG. 12. When it is determined that an available period is set (S38: YES), procedure proceeds to S39.

In S39, the variable M is substituted by “11” by the game controller 100. Thereby, the available period is set in the control system. In S39, by the instruction from the game controller 100 to the graphics board 68, the available period display portion 18 is displayed on the lower image display panel 6, and the message of “during available period!” is displayed in the available period display portion 18. Then it is returned to the main game process as shown in FIG. 12.

Also, in the embodiment, the bet number set in above S11, is the bet number for the unit game which is started right after the setting of the bet number. When the available period is also set before the unit game is started, the bet number may also be used to bet for the available period setting. And also, the bet number setting may be executed independently to the available period setting.

When procedure returns to the main game process shown in FIG. 12, in S13, it is determined whether the spin button 13 is operated by the game controller 100. Whether the spin button 13 is operated is determined based on whether the input signal is received.

When the spin button 13 is not operated (S12: NO), the procedure may be returned to the start acceptance process (S11) again. At this time, correction of the bet number can be done. On the other hand, when the spin button 13 is operated (S12: YES), the bet number, which is set for the pay line L based on the operation of 1-bet button 16 or max-bet button 17, may be subtracted from credit number owned by the player. And, the bet number may be stored in RAM 43 as the bet information.

In S14, the game controller 100 executes the base game with the use of the reels 5L, 5C and 5R.

First, the game controller 100 executes the lottery process in a base game in S14.

Concretely, the random number generation program is included in the lottery program stored in the RAM 43. When the random number generation program is executed, each random numbers corresponding to each of the three reels 5L, 5C and 5R are generated from the predetermined range of the random number (“0” to “255”). With reference to the symbol weighing data corresponding to the payout rate setting data, each code number of reel 5L, 5C and 5R (see FIG. 3) is determined based on three random numbers which are selected. After the determined code numbers of the reels 5L, 5C and 5R are stored in RAM 43, the procedure is shifted to S15.

Here, the code numbers of the video reels 5L, 5C and 5R correspond to the code numbers of the symbols rearranged and displayed on the pay line L. Therefore, the symbol combination in current game is determined based on the code numbers of the reels 5L, 5C and 5R determined by the game controller 100. For example, if it is determined that the code numbers of the reels 5L, 5C and 5R are “21”, “21”, and “21”, the symbol combination may be determined as a winning combination of the “RED7” by the game controller 100. In this way, the lottery for the symbol combination (see FIG. 5) is conducted by determining the code numbers of the reels 5L, 5C and 5R.

In S15, the game controller 100 executes symbol display control process.

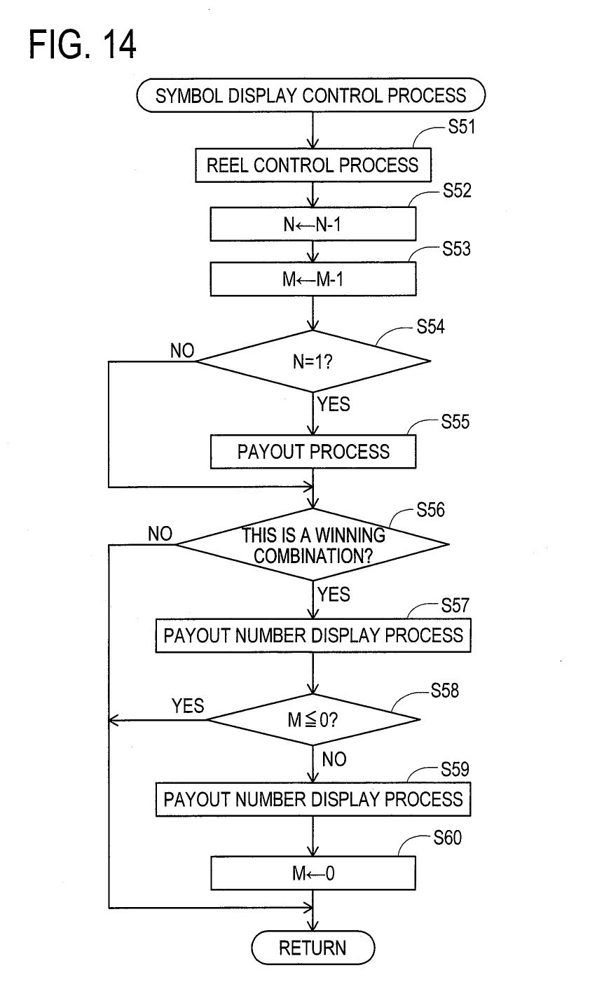

Here, the sub process of the symbol display control process in S15, may be described with reference to FIG. 14. FIG. 14 is a flowchart of the symbol display control process program in the slot machine 1 according to the embodiment. Each program shown in the flowchart of FIG. 14, is stored in the ROM 42 or RAM 43 of the slot machine 1, and is executed by the game controller 100.

First, a reel control process is executed by the game controller 100, in S51 as shown FIG. 14. In the symbol display control process, each of spinning video reels 5L, 5C and 5R may be stopped so that the symbols corresponding to the determined combination of symbols in the base game lottery process (S13) are stopped and displayed on the pay line L. The symbol display control process is executed by the game controller 100 and the graphic board 68.

Concretely, in the symbol display control process (S14), the game controller 100 transmits the start signal to the graphic board 68. The start signal instructs to start the reel spin. When the graphic board 68 receives the start signal, the graphic board 68 executes the reel spin and display process. Namely, the graphic board 68 executes the display control to start the reel spin and display process of each of the reels 5L, 5C and 5R on the lower image display panel 6.

After the start signal is transmitted, the game controller 100 determines an effect pattern (for example, the image display on the upper image display panel 7 and sounds output from the speaker 28), and the determined effect pattern may be conducted.

When it comes the predetermined timing in which the reels 5L, 5C and 5R are to be stopped, the game controller 100 may transmit the code numbers of the reels stored in the RAM 43 to the graphic board 68. The graphic board 68 executes the reel stop process based on the code numbers of the reels. Accordingly, the symbols corresponding to the lottery result in S13 may be stopped and displayed in the each of the display windows 10L, 10C and 10R on the lower image display panel 6.

In S52, the variable N is decreased by “1” by the game controller 100, and procedure proceeds to S53. In S53, the variable M is decreased by “1” by the game controller 100, and procedure proceeds to S54.

In S54, it is determined whether the variable N is “1” by the game controller 100. Here, when the variable N is not “1” (S54: NO), procedure shifts to S56. On the other hand, when the variable N is “1” (S54: YES), procedure proceeds to S55.

In S55, the payout process is executed by the game controller 100. In the payout process, the payout amount corresponding to the above insurance (for example 100 credits) may be paid out to the player. In the payout process, based on the input from the cashout button 15 by a player, coins corresponding to the credits (1 credit equals to 1 coin) may be paid out to the player. And also the coins may be paid out according to the ticket with bar code 25.

In S56, it is determined whether there is a winning combination by the game controller 100. This determination is made based on the code Nos. stored in the RAM 43 in S14 or the first payout table (see FIG. 5). When it is determined that there is no winning combination (S56: NO), procedure returns to the main game process shown in FIG. 12. When it is determined that there is a winning combination (S56: YES), the procedure proceeds to S57.

In S57, the payout amount display process is executed by the game controller 100. In the payout amount display process, based on the instruction from the game controller 100 to the graphic board 68, the payout amount corresponding to the winning combination determined in above S56 may be displayed, on the payout amount display portion 9 of the lower image display panel 6. And the payout amount may be stored in the RAM 43 as the payout information.

And then, in S58, it is determined whether the variable M is under “0” by the game controller 100. When it is determined that the variable M is under “0” (S58: YES), procedure returns to the main game process shown in FIG. 12, and it indicates the game is not in an available period. However, when it is determined that the variable M is bigger than “0” (S58: NO), procedure proceeds to S59. At this time, it is in an available period.

In S59, the payout amount display process is executed by the game controller 100. Here, the value of “11−M” (in which M is subtracted from 11) is calculated as the number of times regarding the unit game in the second payout table (see FIG. 6). And the multiple corresponding to the calculated game number is determined from the second payout table (see FIG. 6).

And then, based on the instruction from the game controller 100 to the graphic board 68, the determined multiple may be displayed on the available period display portion 18 of the lower image display panel 6. And the game controller 100 calculates the payout amount by multiplying the payout information obtained in S57 with the determined multiple. Based on the instruction from the game controller 100 to the graphic board 68, the payout amount calculated in S59 is displayed on the payout amount display portion 9 of the lower image display panel 6. And the payout amount may be stored in the RAM 43 as new payout information.

Then, in S60, the variable M is substituted by “0” through the game controller 100. Thereby, the available period is terminated forcibly. And procedure returns to the main game process shown in FIG. 12.

When the game procedure returns to the main game process shown in FIG. 12, in S16, it is determined whether there is a winning combination by the game controller 100. This determination is made in the same way as that in S56. As the result, when it is determined that there is no winning combination (S16: NO), the program may be executed again. When it is determined that there is a winning combination (S16: YES), procedure proceeds to S17.

In S17, it is determined whether a bonus trigger is satisfied in the base game by the game controller 100. Concretely, when the first payout table shown in FIG. 5 is used, it is determined that a bonus trigger is satisfied when the symbol combination constructed from three “RED 7” is rearranged and displayed on the payout line L.

When it is determined that a bonus trigger is satisfied (S17: YES), in S18, a selection-type bonus game process may be executed by the game controller 100. Here, regarding to the bonus game process, the detailed explanation will be omitted. Thereinafter, the payout process may be executed in S19 by the game controller 100, including the case that a bonus trigger is not satisfied (S17: NO). In the payout process, the payout corresponding to the base game and the bonus game may be done respectively to the player. Here, the payout amount obtained in the base game may be stored in the RAM 43 in S19 as new payout information.

And in the payout process, based on that the cashout button 15 is operated, coins (one credit equals to one coin) corresponding to the credit number may be paid out to the player or coins may be paid out through the ticket with bar code 25.

As explained in detail above, in a base game executed by the slot machine 1 according to the embodiment, when the bet number is set in S11 based on the operation of 1-BET button 16 or the max-BET button 17, if the game is not in an available period (S35: NO), the second setting screen shown in FIG. 10 may be displayed on the lower image display panel 6 (S37). Here, when the “YES” button 105 is pressed by the player (S38: YES), and then an available period during which unit games are executed continuously ten times, is set (S39, S53 and S58).

And in the unit game during the available period (S58: NO), through the display windows 10L, 10C and 10R of the lower image display panel 6, when the symbol combination rearranged and displayed on the payout line L is a winning combination (S56: YES), the payout amount per winning combination may be provided to the player (S57, S59 and S19). Therefore, regarding to the bet number setting, new manner is added thereto, thus new entertaining characteristic can be provided.

In case that a winning combination is satisfied in the unit game during the available period, the less the number of times of the unit game conducted between the starting game and this unit game becomes, the bigger the multiple to multiply the payout amount per winning combination becomes (S59). Here, based on the second payout table shown in FIG. 6, for example, when the unit game, in which the winning combination is realized during the available period, corresponds to the first unit game (corresponding to the starting point of the available period, that is, the unit game conducted in the first time), the multiple is “20”, and the payout amount provided to the player is twenty-times of the payout amount per winning combination. Further, when the unit game, in which the winning combination is realized during the available period, corresponds to the seventh unit game from the staring game, the multiple is “5”, and the payout amount provided to the player is five-times of the payout amount per winning combination. In other words, when a winning combination is satisfied during the available period, the less the remained number of times of the unit game included in the available period becomes, the smaller the multiple multiplied to the payout amount per winning combination becomes. Therefore, the remained number of times of the unit game included in the available period, may have more influences on the mentality of the player.

And when a winning combination is satisfied during the available period (S56: YES, S58: NO), the available period is terminated forcibly (S60). Thereby, regarding to the bet number setting, new manner may added to its content, and new entertaining characteristic may be added to the game.

In the base game executed by the slot machine 1 according to the embodiment, only in a case that the insurance, according to which a predetermined payout amount (for example, 100 credits) is paid out to the player based on that the unit game is repeated in a predetermined number of times (here, 100 times), is betted (S36: YES), the second setting screen shown in FIG. 10 is displayed on the lower image display panel 6 and the player can set the available period (S37). Thereby, regarding to the bet number setting, new manner may be added to its content, and new entertaining characteristic may be added to the game. A player may secure the resource of his payout amount associated with the available period by betting on the insurance.

Here, the slot machine is not limited to the above embodiment.

For example, during the available period, only in a case that a specific winning combination is realized in the unit game, the payout amount may be increased by multiplying a predetermined multiple with the payout amount per winning combination. In this case, in addition to that the bet number set in above S11 is set in the unit game which is started right after such bet number is set, it concludes that the bet number set in above S11 may be bet in the unit game during the available period which is counted from the starting game started right after such bet number is set, based on that the specific winning combination is realized in such unit game. Also, the bet number setting may be executed separately.

And even if a winning combination is realized (S56: YES, S58: NO) during the available period, the available period may be continued without being terminated forcibly by skipping S60. Thereby, regarding to the bet number setting, new manner may added to its content, and new entertaining characteristic can be provided in the game.

And at the time that a winning combination is realized during the available period, the multiple multiplied with the payout amount per winning combination may be set to the same value, with no relation to the number of times of the remaining unit game constructing the available period. The payout amount obtained by multiplying the multiple may be regarded as a payout amount with no relation to the game result of the current game such as a mystery bonus game.

And, in a case that a winning combination is realized during the available period, a predetermined payout amount preset independently may be provided or the game state may be proceeded to the bonus game, instead of increasing the payout amount by multiplying a predetermined multiple to the payout amount per winning combination.

The available period may also be constructed from a predetermined time instead of a predetermined number of times of the unit game.

Although only one payout line L is included in the slot machine 1 according to the embodiment, plural payout lines activated corresponding to the bet number may be included.

The above concept may also be applied to the other gaming machines such as the mass game machine and the like, in addition to the slot machine.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A gaming machine comprising:
a display device on which a plurality of symbols are arranged in each of unit games;
a bet portion for setting a bet number; and
a processor programmed to
(a) set an available period starting from a time that the bet number is set by the bet portion,
(b) determine whether a symbol combination which is constructed from the symbols arranged on the display during the available period is a predetermined winning combination; and
(c) provide an award when the symbol combination is the predetermined winning combination.

2. The gaming machine according to claim 1, wherein the processor makes a difference in the award based on a remaining period of the available period at a time that the predetermined winning combination is arranged when the processor provides the award.

3. The gaming machine according to claim 1, wherein the processor continues the available period when the remaining period exists in the available period at a time that the processor provides the award.

4. The gaming machine according to claim 1, wherein the processor terminates the available period even in a case that the remaining period exists in the available period at the time that the processor provides the award.

5. The gaming machine according to claim 1, wherein the processor permits to set the available period from the time that the bet number is set by the bet portion only in a case that an insurance is bet for repeating the unit game in a predetermined number of times.

6. A gaming method comprising steps of:
setting a bet number through a bet portion when a unit game in which a plurality of symbols are arranged on a display device is progressed by repeating thereof;
setting an available period starting from a time that the bet number is set by the bet portion; and
providing an award when a symbol combination arranged on the display device during the available period is a predetermined winning combination.

7. The gaming method according to claim 6, further comprising a step of:
making a difference in the award based on a remaining period of the available period at a time that the predetermined winning combination is arranged when the award is provided.

8. The gaming method according to claim 6, comprising a step of:
continuing the available period when the remaining period exists in the available period at a time that the award is provided.

9. The gaming method according to claim 6, comprising a step of:
terminating the available period even in a case that the remaining period exists in the available period at the time that the award is provided.

10. The gaming method according to claim 6, comprising a step of:
permitting to set the available period from the time that the bet number is set by the bet portion only in a case that an insurance is betted for repeating the unit game in a predetermined number of times.
